(19) United States
(12) Patent Application Publication
(10) Pub. No.: US 2025/0222349 A1
(43) Pub. Date: Jul. 10, 2025

(54) INTEGRATION OF A GAME ENGINE WITH A SERVICE ENGINE

(71) Applicant: Playtika LTD, Herzeliya (IL)

(72) Inventors: Noy BELGI, RaAnana (IL); Ilia MALANIN, Warsaw (PL)

(73) Assignee: Playtika LTD, Herzeliya (IL)

(21) Appl. No.: 19/010,010

(22) Filed: Jan. 5, 2025

Related U.S. Application Data
(60) Provisional application No. 63/617,779, filed on Jan. 5, 2024.
(60) Provisional application No. 63/617,791, filed on Jan. 5, 2024.

(51) Int. Cl. A63F 13/35; A63F 13/79; G06F 8/41

(52) U.S. Cl. CPC A63F 13/35; A63F 13/79; G06F 8/427

(57) ABSTRACT

There is provided a computer implemented method of integration of a game engine with a service engine, comprising: obtaining a source code operative to implement a game engine designed to interact with a plurality of players, applying a machine learning (ML) model to the source code, wherein the ML model is pre-trained to identify at least one region in the source code to be modified to convey, to the service engine, at least one data element indicating interaction of the plurality of players with the game engine, and receiving, from the ML model, at least a suggestion indicating modification of the at least one region of the source code to send the at least one data element to the service engine, during interaction of the players with the game engine.

### RELATED APPLICATIONS

This application claims the benefit of priority under 35 USC § 119(e) of U.S. Provisional Patent Application No. 63/617,779 and U.S. Provisional Patent Application No. 63/617,791, both filed on Jan. 5, 2024. The contents of the above applications are all incorporated by reference as if fully set forth herein in their entirety.

### FIELD AND BACKGROUND OF THE INVENTION

The present invention, in some embodiments thereof, relates to game engines and, more specifically, but not exclusively, to systems and methods for integrating game engines with service engines.

A game engine is an execution platform for running a game. When the game is being executed by the game engine, data is conveyed from the game engine to the service engine, usually via a communication network as the game engine and service engine are typically hosted by two different servers.

### SUMMARY OF THE INVENTION

According to a first aspect, computer implemented method of integration of a game engine with a service engine, comprises: obtaining a source code operative to implement a game engine designed to interact with a plurality of players, applying a machine learning (ML) model to the source code, wherein the ML model is pre-trained to identify at least one region in the source code to be modified to convey, to the service engine, at least one data element indicating interaction of the plurality of players with the game engine, and receiving, from the ML model, at least a suggestion indicating modification of the at least one region of the source code to send the at least one data element to the service engine, during interaction of the players with the game engine.

According to a second aspect, a system for integration of a game engine with a service engine, comprises: at least one processor executing a code for: obtaining a source code operative to implement a game engine designed to interact with a plurality of players, applying a machine learning (ML) model to the source code, wherein the ML model is pre-trained to identify at least one region in the source code to be modified to convey, to the service engine, at least one data element indicating interaction of the plurality of players with the game engine, and receiving, from the ML model, at least a suggestion indicating modification of the at least one region of the source code to send the at least one data element to the service engine, during interaction of the players with the game engine.

According to a third aspect, a computer implemented method for training a ML model to identify at least one region in the source code to be modified to convey, to a service engine, at least one data element indicating interaction of a plurality of players with the game engine, comprises: creating a training dataset of a plurality of records, wherein a record includes: a sample source code of a sample game engine, and a ground truth indicating at least one region in the sample code to be modified to convey, to a sample service engine, information related to how the plurality of players interact with the sample game engine, and at least one recommendation for adapting the at least one region, and training the ML model on the training dataset.

In a further implementation form of the first, second, and third aspects, at least the suggestion comprises at least marking, in the source code, the modifications to make to the at least one region of the source code to be operative to send the at least one data element indicating interaction of the plurality of players with the game engine.

In a further implementation form of the first, second, and third aspects, at least the suggestion comprises actually making, by the ML model itself and/or an accompanying agent, in the at least one region of the source code, the modification to make the source code operative to send the at least one data element indicating interaction of the plurality of players with the game engine.

In a further implementation form of the first, second, and third aspects, further comprising: making, in the at least one region of the source code, according to the at least the suggestion, the modifications to make the source code operative to send the at least one data element indicating interaction of the plurality of players with the game engine, and compiling the source code including the modifications to create an executable code operative to, in addition to implementing the game engine, also execute the conveying, to the service engine, the at least one data element indicating interaction of the plurality of players with the game engine.

In a further implementation form of the first, second, and third aspects, further comprising: sending, by the game engine, to the service engine, while the game engine incorporating the modifications is executing and the plurality of players are interacting with the game engine, the at least one data element indicating the interaction of the plurality of players with the game engine.

In a further implementation form of the first, second, and third aspects, the at least one data element indicating interaction of the plurality of players with the game engine comprises at least one of: (i) activity logs, (ii) time spent in various attractions/stages within the game engine, (iii) interactions between the different players, (iv) gaming status, (v) inventory of in-game items, (vi) in-game trading, (vii) entire and/or part of a data structure describing a state of each of at least one of the players, (viii) in-game messages created by the players, (ix) latencies as experienced by the players in conjunction with playing the game, (x) a log of user interface activities comprising interactions with a user screen in conjunction with player the game, (xi) interactions with in-game stores, (xii) interactions with an in-game specific activities, (xiii) in-game token and/or currency status, (xiv) technical fault experienced by the players, and (xv) stages in purchasing funnel.

In a further implementation form of the first, second, and third aspects, the conveying of the at least one data element is done via a selected protocol for communicating with a virtual interface of the service engine over a communication network, wherein the game engine is hosted by a first server that is different than a second server hosting the service engine.

In a further implementation form of the first, second, and third aspects, the modifications done to the source code are operative for the service engine to access at least one database of the game engine storing data generated by interaction of the plurality of players with the game engine used to compute the at least one data element.

In a further implementation form of the first, second, and third aspects, the modifications done to the source code are operative to access, by the service engine, in-game messages associated with the plurality of players interacting with the game engine.

In a further implementation form of the first, second, and third aspects, the modifications done to the source code are operative to access, by the service engine, a data state associated with at least one of the plurality of players.

In a further implementation form of the first, second, and third aspects, the modifications done to the source code are operative to generate, in conjunction with the game engine, intermediate data bases and/or data structures operative to store intermediate data elements to facilitate the conveying, to the service engine, the at least one data element indicating interaction of the plurality of players with the game engine.

In a further implementation form of the first, second, and third aspects, the intermediate data bases and/or data structures comprise at least one of: (i) streaming buffers, (ii) intermediate calculation buffers, and (iii) per-player databases operative to aggregate a current state of each of the players.

In a further implementation form of the first, second, and third aspects, further comprising: generating, by the ML model, and/or by another model working in conjunction with the ML model, metadata describing and/or characterizing the at least one data element indicating interaction of the plurality of players with the game engine.

In a further implementation form of the first, second, and third aspects, the describing and/or characterizing comprises segmentation of the at least one data element into categories and/or priorities.

In a further implementation form of the first, second, and third aspects, further comprising: generating, by the ML model, and/or by another model working in conjunction with the ML model, a metadata summary usable by a user of the service engine to facilitate interaction with and/or understanding of the at least one data element indicating interaction of the plurality of players with the game engine.

In a further implementation form of the first, second, and third aspects, the modifications done to the source code are operative to generate, in conjunction with the game engine, an interactive interface usable by a user of the service engine to facilitate performing of a selection of which types of data elements to actively receive from the at least one data element indicating interaction of the plurality of players with the game engine.

In a further implementation form of the first, second, and third aspects, the modifications done to the source code are operative to generate, in conjunction with the game engine, an interactive interface usable by a user of the service engine to facilitate adjustments regarding generation and/or reception of the at least one data element indicating interaction of the plurality of players with the game engine.

In a further implementation form of the first, second, and third aspects, the adjustments are associated with selecting aspects-to-be-revealed in conjunction with how the plurality of players interact with the game engine, wherein the selected aspects-to-be-revealed correspond to a set of candidate data elements.

In a further implementation form of the first, second, and third aspects, the game engine is configurable for communicating with a plurality of different service engines running on a plurality of different computing platforms, and the source code is modified for the game engine to communicate with a specific service engine.

In a further implementation form of the first, second, and third aspects, the ML model is trained on a training dataset of a plurality of records, wherein a record includes a sample source code of a sample game engine, and a ground truth indicating at least one region in the sample code to be modified to convey, to a sample service engine, information related to how the plurality of players interact with the sample game engine.

In a further implementation form of the first, second, and third aspects, the ground truth of the record further comprises at least one recommendation for adapting the at least one region.

In a further implementation form of the first, second, and third aspects, further comprising: monitoring interactions of the plurality of players with the game engine created by compiling the source code, wherein the ML model is applied to the source code of the service engine to identify the at least one region in the source code to be modified to convey, to the service engine, the at least one data element indicating the monitored interaction of the players with the game engine.

In a further implementation form of the first, second, and third aspects, further comprising: analyzing the monitored interaction to identify the at least one data element to convey to the service engine, wherein the ML model is applied to the source code of the service engine to identify the at least one region in the source code to be modified to convey, to the service engine, the identified data.

In a further implementation form of the first, second, and third aspects, further comprising dynamically iterating the applying, the receiving, the monitoring the interactions, and the analyzing, for dynamic adaptation of the source code according to dynamic interactions between the plurality of players and the game engine.

In a further implementation form of the first, second, and third aspects, the ML model identifies the at least one region of the source code for improving performance of a computing platform running the game engine and/or a computing platform running the service engine in view of interaction of the players with the game engine.

In a further implementation form of the first, second, and third aspects, the monitoring is performed by a monitoring agent embedded within the game engine.

In a further implementation form of the first, second, and third aspects, applying comprises applying the ML model to the source code in combination with a set of aspects-to-be-revealed in conjunction with how the plurality of players interact with the game engine, wherein the set of aspects-to-be-revealed correspond to a set of candidate data elements, and wherein the suggestion indicates modification of the source code to be able to send at least one data element, during interaction of the players with the game engine, to reveal the aspects in the set.

In a further implementation form of the first, second, and third aspects, further comprising: extracting at least one feature from the source code, the at least one feature associated with at least one region in the source code, wherein the ML model is applied to the at least one feature, wherein the at least one suggestion is for modification of the at least one region corresponding to the at least one feature.

In a further implementation form of the first, second, and third aspects, wherein: extracting at least one feature comprises converting the source code to a generic abstract syntax tree (AST) representation that is independent of language-specific syntax of a programming language used to write the source code, wherein the ML model is applied to the generic AST representation, wherein the at least one suggestion is for modification of at least one region of the generic AST representation.

In a further implementation form of the first, second, and third aspects, at least the suggestion comprises actually making, by the ML model itself and/or an accompanying agent, the modification in the at least one region of the generic AST representation to generate a modified AST representation, and further comprising reconverting the modified AST representation to a modified source code in an original programming language used to write the source code.

In a further implementation form of the first, second, and third aspects, the ML model is trained on a training dataset of a plurality of records, wherein a record includes a sample generic AST representation created from a sample source code of a sample game engine, and a ground truth indicating at least one region in the sample generic AST representation to be modified to convey, to a sample service engine, information related to how the plurality of players interact with the sample game engine.

In a further implementation form of the first, second, and third aspects, the training dataset is created from sample source code written in a plurality of different programming languages.

In a further implementation form of the first, second, and third aspects, a compilation of the game engine runs on a first server that is different than a second server running the service engine, where the at least one data element is created by the game engine while being interacted with by players, and the at least one data element is conveyed from the first server to the second server over a network.

In a further implementation form of the first, second, and third aspects, the at least one processor executing the code for obtaining the source code, applying the ML model, and receiving, runs on a third sever different from the first server and the second server.

In a further implementation form of the first, second, and third aspects, further comprising: extracting at least one feature from the sample source code, the at least one feature associated with at least one region in the sample source code, wherein the record includes the extracted at least one feature, wherein the ground truth indicates the at least one region to be modified corresponding to the at least one feature.

In a further implementation form of the first, second, and third aspects, wherein extracting at least one feature comprises converting the sample source code to a generic AST representation, wherein the ground truth indicates the at least one region of the generic AST representation to be modified.

In a further implementation form of the first, second, and third aspects, the training dataset is created from records for a plurality of different sample source code written in a plurality of different programming languages.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for automatically identifying one or more regions of a source code of a game engine to be modified and/or for automatically modifying the region(s), to convey, to a service engine, one or more data elements indicating interaction of multiple players with the game engine, in accordance with some embodiments of the present invention;

FIG. 2 is a flowchart of a method for automatically identifying one or more regions of a source code of a game engine to be modified and/or for automatically modifying the region(s), to convey, to a service engine, one or more data elements indicating interaction of multiple players with the game engine, in accordance with some embodiments of the present invention;

FIG. 3 is a flowchart of a method for training a ML model for automatically identifying one or more regions of a source code of a game engine to be modified and/or for automatically modifying the region(s), to convey, to a service engine, one or more data elements indicating interaction of multiple players with the game engine, in accordance with some embodiments of the present invention; and

FIGS. 4A-4D depict an example of using an abstract syntax tree (AST) representation of source code of the game engine for modification thereof, in accordance with some embodiments of the present invention.

### DESCRIPTION OF SPECIFIC EMBODIMENTS OF THE INVENTION

The present invention, in some embodiments thereof, relates to game engines and, more specifically, but not exclusively, to systems and methods for integrating game engines with service engines.

An aspect of some embodiments of the present invention relates to systems, methods, computing devices, and/or code instructions (stored on a data storage device and executable by one or more processors) for facilitating integration (e.g., faster than existing approaches) of a game engine with a service engine. The game engine is an execution platform for running a game. When the game is being executed by the game engine, data elements are conveyed from the game engine to the service engine while the game is being played. The data elements may be conveyed via a communication network between a server running the game engine and another server running the service engine. A source code for implementing the game engine is accessed. The game engine is designed to interact with multiple players, optionally by running on a server, where multiple players using multiple client terminals interact with the game engine over a network. The source code is fed into a machine learning (ML) model. The ML model is pre-trained to identify one or more regions of the source code which are to be modified to convey, to the service engine, one or more data elements indicating interaction of the players with the game engine. The ML model generates an outcome of one or more suggestions indicating modification of the region(s) of the source code to send the data elements to the service engine, during interaction of the players with the game engine.

Optionally, the source code is fed into the ML model in combination with a set of aspects-to-be-revealed, which may represent aspects of interactions that are of a particular interest to the user of the service engine. The aspects-to-be-revealed may correspond to one or more (e.g., a set) of the data elements that are available. The set of aspects-to-be-revealed may be selected from the set of the data elements, for example, as the data elements that the user wishes to convey to the service engine from the game engine. The suggestion obtained as the outcome of the ML model may further indicate modification of the source code to be able to send the data element(s), during interaction of the players with the game engine, to reveal the aspects in the set, for example, by presenting the aspects on a display (e.g., within a user interface), and the like. The aspects may be updated in real time in response to interactions of players with the game engine compiled from the modified source code.

At least some embodiments described herein address the technical problem of facilitating integration of a game engine with a service engine that is in communication with the game engine. At least some embodiments described herein improve the technology of integration tools, in particular for enabling a game engine to communicate with a service engine, where the game engine and service engine may be executing on different computational platforms. At least some embodiments described herein improve upon prior approaches for integration of a game engine with a service engine, for example, manual modification of the source code of the game engine.

A certain game engine may be selected by a developer from multiple available game engines, and a certain service engine may be selected by the developer from multiple available service engines. The service engine and/or the game engine may run within different respective computational platforms, for example, on a server and/or computing cloud, to enable multiple client terminals used by multiple players to interact with the game engine.

Since there are different combinations of possible game engines with possible service engines, the source code of the selected game engine is modified for integration with the selected service engine. The integration is traditionally performed manually by a software developer, by manual modification of the source code.

At least some embodiments described herein address the aforementioned technical problem, and/or improve the aforementioned technical field, and/or improve the aforementioned technical field by feeding a source code of a game engine into an ML model trained to identify one or more regions in the source code to be modified to convey, to the service engine, one or more data elements indicating interaction of multiple players with the game engine. The ML model may automatically suggest the modification, and/or may automatically make the modifications to the source code. Interactions of multiple players with the running game engine may be monitored, optionally in real time by providing data elements from the game engine to the service engine. The source code may be iteratively and/or dynamically adapted according to the monitoring, for example, to improve performance of the service engine's execution of the game engine, for example, by adapting the data element(s) to convey to the service engine in response to the monitored interactions of the players with the game engine.

The integration may offer various benefits, such as enhanced multiplayer functionality, real-time updates, analytics, and more. However, integration may be complex and/or time consuming using manual approaches, due to multiple different factors that may be integrated. Embodiments described herein are designed to facilitate fast integration between the game engine and service engine, and/or to reduce errors during the integration, and/or to integrate a larger number of features, for example, in compared to standard approaches, such as standard manual modification of source code.

Examples of feature of integration that are improved by embodiments described herein include:
Defining clear and well-documented APIs for communication between the game engine and the service engine. This may include defining endpoints, data formats (e.g., JSON), and authentication mechanisms.
Implementing secure authentication and authorization mechanisms to ensure that only authorized users and game instances can access the services, for protecting sensitive data and ensuring fair play in multiplayer scenarios.
Setting up communication protocols between the game client and the service engine, depending on the specific requirements.
Designing and implementing the necessary features to support real-time communication between players. This may include, for example, synchronization of game state, handling player movements, and managing in-game events.
Determining how and where game-related data will be stored. This may involve, for example, using databases, cloud storage, or a combination of both. Ensuring efficient mechanisms for data retrieval and storage to minimize latency.
Implementing event-driven architectures to handle various in-game events, such as player actions, achievements, and updates. This allows for real-time responsiveness and synchronization.
Integrating monitoring tools and analytics to gather insights into the performance of both the game and service components. This information can be valuable for improving user experience and identifying areas for optimization.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

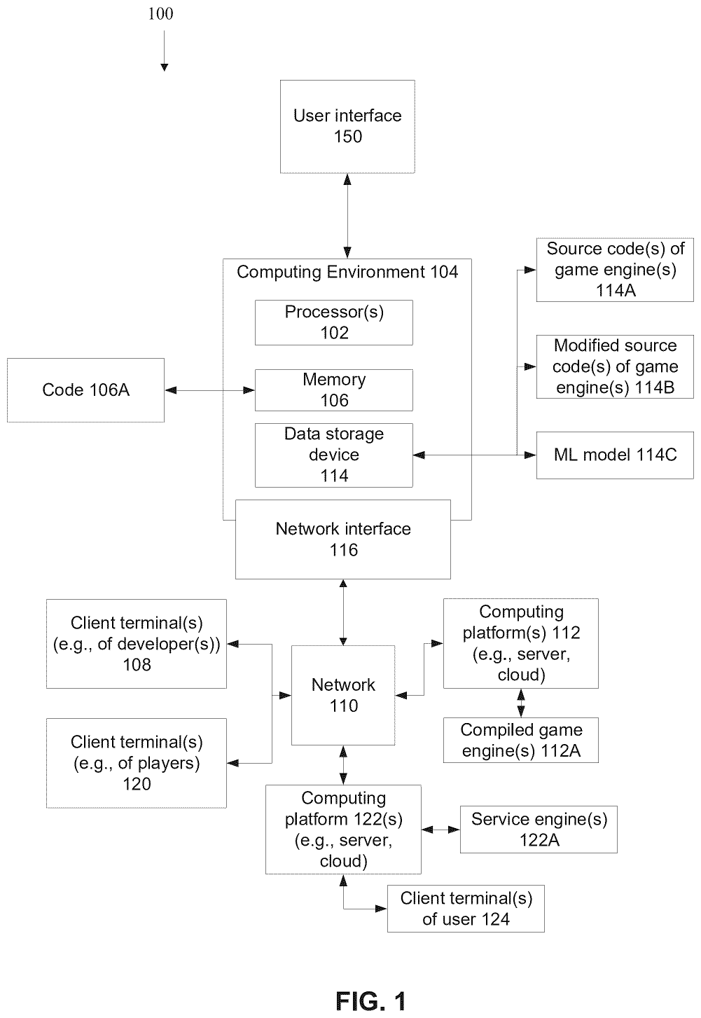

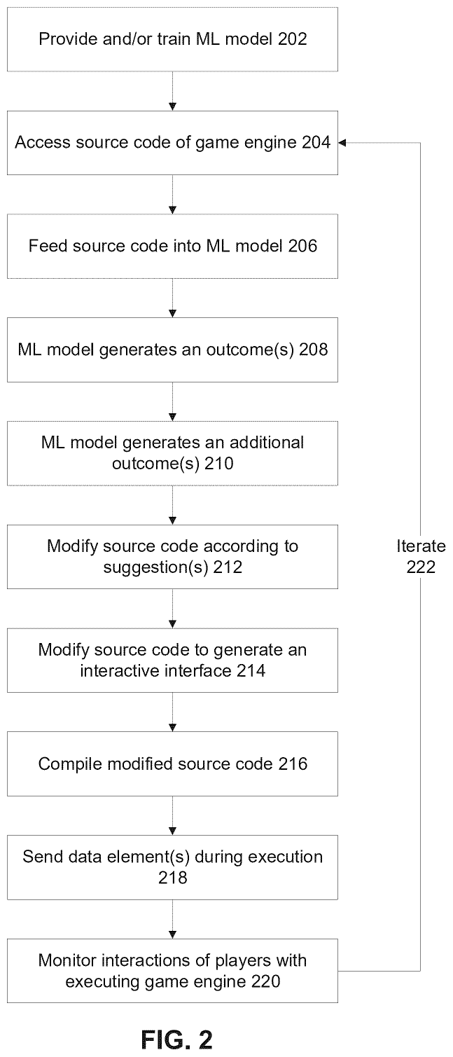

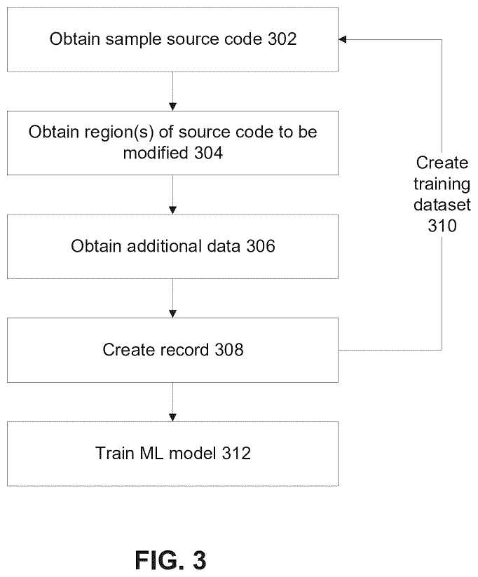

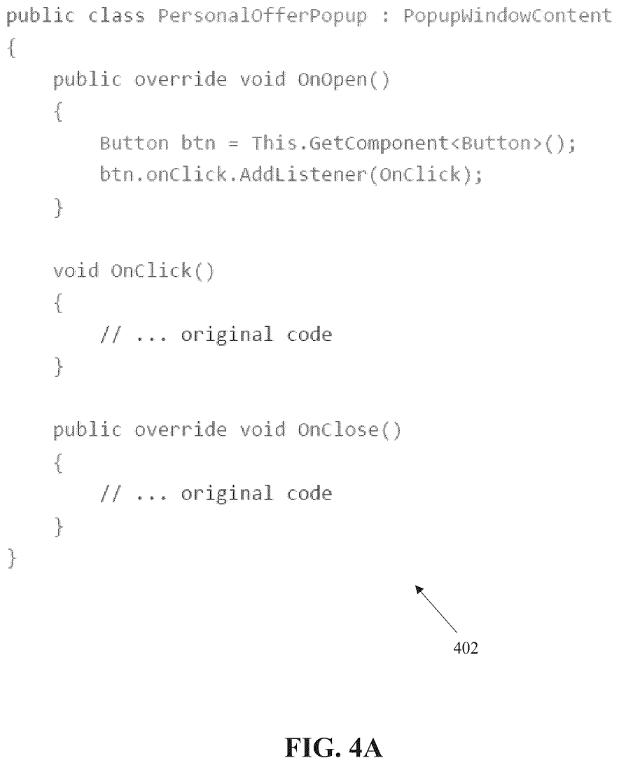

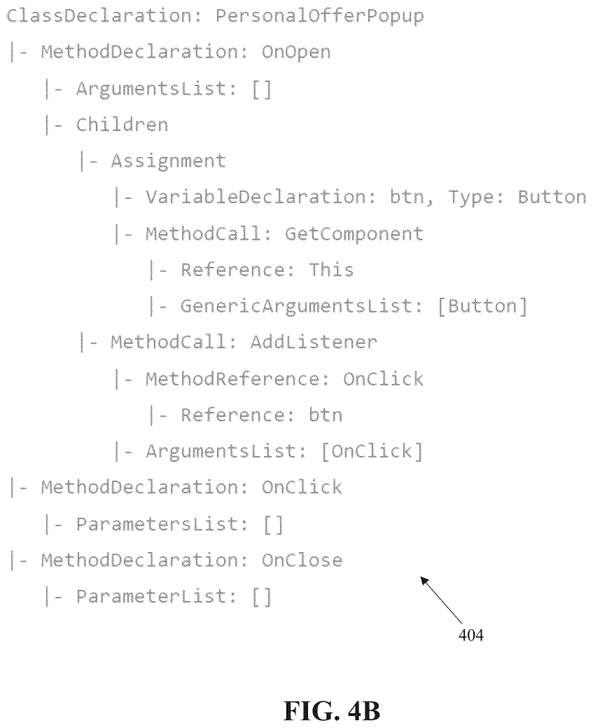

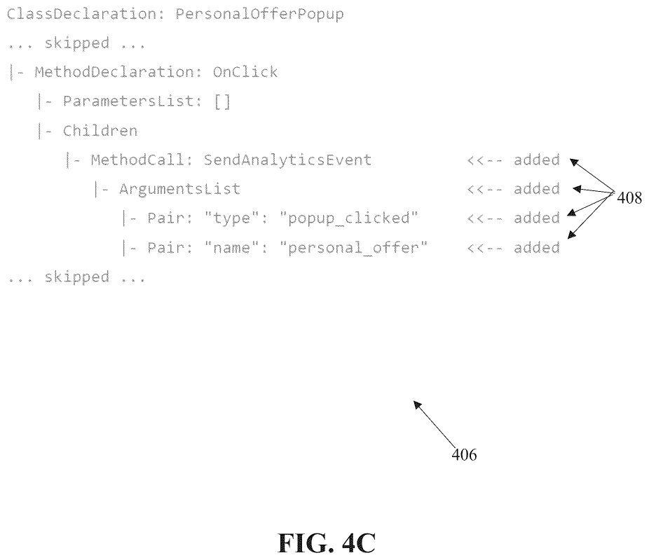

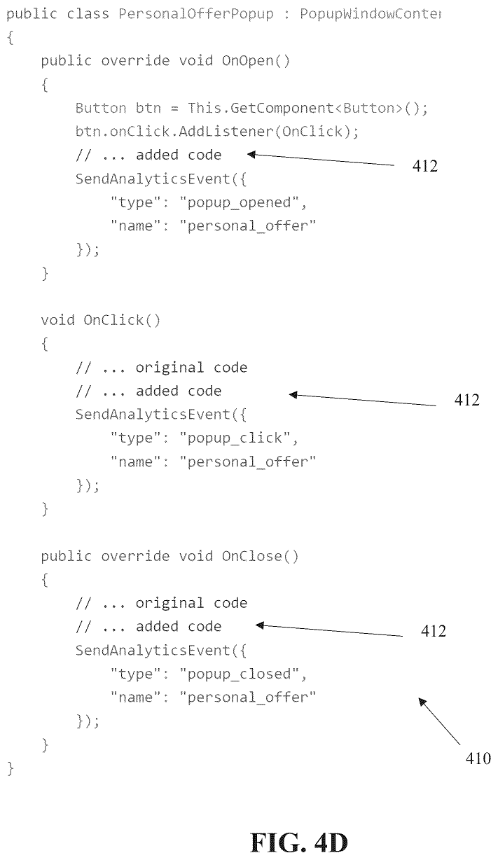

Reference is now made to FIG. 1, which is a block diagram of components of a system 100 for automatically identifying one or more regions of a source code of a game engine to be modified and/or for automatically modifying the region(s), to convey, to a service engine, one or more data elements indicating interaction of multiple players with the game engine, in accordance with some embodiments of the present invention. Reference is also made to FIG. 2, which is a flowchart of a method for automatically identifying one or more regions of a source code of a game engine to be modified and/or for automatically modifying the region(s), to convey, to a service engine, one or more data elements indicating interaction of multiple players with the game engine, in accordance with some embodiments of the present invention. Reference is also made to FIG. 3, which is a flowchart of a method for training a ML model for automatically identifying one or more regions of a source code of a game engine to be modified and/or for automatically modifying the region(s), to convey, to a service engine, one or more data elements indicating interaction of multiple players with the game engine, in accordance with some embodiments of the present invention. Reference is also made to FIGS. 4A-4D, which depict an example of using an abstract syntax tree (AST) representation of source code of the game engine for modification thereof, in accordance with some embodiments of the present invention.

System 100 may implement the acts of the method described with reference to FIGS. 2-4A-D by processor(s) 102 of a computing environment 104 executing code instructions 106A stored in a memory 106 (also referred to as a program store).

Computing environment 104 may be implemented as, for example one or more and/or combination of: a computing cloud, a group of connected devices, a server, a virtual server, a client terminal, a virtual machine, a desktop computer, a thin client, a network node, and/or a mobile device (e.g., a Smartphone, a Tablet computer, a laptop computer, a wearable computer, glasses computer, and a watch computer).

Computing environment 104 may feed source code of game engine 114A into ML model 114E for generating modified source code of game engine 114B, as described herein, for example, obtaining indication of region(s) of the source code 114A to modify, recommendations for modifications, and/or by automatically making the modifications.

A studio (not shown) may compile modified source code of game engine 114B into compiled game engine 112A.

Compiled game engine 112A may be hosted by a computing platform 112, for example, a server and/or computing cloud. Game engine 112A is designed for interactions, optionally simultaneously, by multiple players, optionally using respective client terminals 120 via a network 110.

A service engine 122A may be hosted by a computing platform 122, for example, a server and/or computing cloud. Service engine 122A receives the data elements created by modified source code 114A running as game engine 112A while the game is being played and interacted with by the players. Optionally, the data elements and/or other aspects-to-be-revealed are provided to one or more client terminals 124 (e.g., of user(s)), for example, presented on a display thereof. The user(s) of client terminal(s) 124 may monitor player interactions by observing and/or analyzing the data elements, and optionally consequently making decisions.

Computing platform 122 running service engine 122A may be different than computing platform 112 running compiled game engine 112A.

Multiple architectures of system 100 based on computing device 104 may be implemented. For example:
Computing environment 104 may be separate from computing platform 122 and/or from computing platform 112. Alternatively, computing environment 104 is operated by, running on, and/or integrated with computing platform 122.
Computing environment 104 may centrally identify regions in different source codes 114A of different game engines 114B using one or more ML models 114C, for generating different compiled engines 122A for interacting with different service engines. Game engines 112A may run on different computing platforms 112. Service engines 122A may run on different computing platforms 122. Source code 114A may be provided to computing environment 104 by different client terminals 108 of different users such as developers. The outcome of the ML model 114C (e.g., identified regions, recommendations for modifications, automatic modifications of the source code) may be provided back to the corresponding client terminals 108, for example, for presentation on a display for manual review and/or additional coding by the developer.
Computing environment 104 may identify region(s) (and/or recommend modifications and/or automatically modify the regions and/or obtain outcomes described herein) in source code of a specific game engine 114A using a specially trained ML model 114C.
Computing environment 104 may identify region(s) (and/or recommend modifications and/or automatically modify the regions and/or obtain outcomes described herein) in source code of one or more game engines 114A for running on a specific computing platform 112.
Computing environment 104 may identify region(s) (and/or recommend modifications and/or automatically modify the regions and/or obtain outcomes described herein) in source code of one or more game engines 114A for interacting with on one or more game engines 112A, optionally specific game engine(s) 112A.
Computing environment 104 may assist developers in obtaining modified source code of game engine 114B by performing the identification of the regions of source code of the game engine 114A (and/or recommend modifications and/or automatically modify the regions and/or obtain outcomes described herein) using ML model 114C. Compiled game engine 112A (generated by compiling modified source code of the game engine 114B generated based on outcome of ML model 114C fed source code of game engine 114A) may be hosted by computing platform 112.
Computing environment 104 may be locally run by a certain developer or development entity, for example, creating a specific game using source code of game engine 114A. For example, the developer uses computing environment 104 to generated modified source code of game engine 114B. The modified source code 114B may then be locally compiled by locally running the studio, or transmitted to the studio running on another device (e.g., server) for complication. Complied game engine 114A may be run by computing platform 112 which is different than computing environment 104.

Computing environment 104 may provide the service of generating outcomes (e.g., identified regions, recommendations, automatic modification, and other as described herein) of ML model 114C in response to input of source code of the game engine 114A, for example by: providing software as a service (SaaS) to the client terminal(s) 108, providing software services accessible using a software interface (e.g., application programming interface (API), software development kit (SDK)), providing an application for local download to the client terminal(s) 108, providing an add-on to a web browser running on client terminal(s) 108, and/or providing functions using a remote access session to the client terminals 108, such as through a web browser executed by client terminal 108 accessing a web site hosted by environment device 104 such as remote access of computing environment 104.

Processor(s) 102 of computing environment 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-4A-D when executed by processor(s) 102.

Computing environment 104 may include a data storage device 114 for storing data, for example, source code(s) of game engine(s) 114A, modified source code(s) of game engine(s) 114B, ML model 114C, and/or other data as described herein. Data storage device 114 may be implemented as, for example, a memory, a local hard-drive, virtual storage, a removable storage unit, an optical disk, a storage device, and/or as a remote server and/or computing cloud (e.g., accessed using a network connection). It is noted that code stored on data storage device 114 may be loaded into memory 106 for execution by processor(s) 102.

Network 110 may be implemented as, for example, the internet, a local area network, a virtual network, a wireless network, a cellular network, a local bus, a point to point link (e.g., wired), and/or combinations of the aforementioned.

Computing environment 104 may include a network interface 116 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 (and/or other components such as client terminals 108, 120, 124) includes and/or is in communication with one or more physical user interfaces 150 that include a mechanism for a user to enter data (e.g., make manual modification to the source code of the game engine) and/or view data (e.g., view the regions of the source code to modify as automatically identified by ML model 114C). Exemplary user interfaces 150 include, for example, one or more of, a touchscreen, a display, a virtual reality display (e.g., headset), gesture activation devices, a keyboard, a mouse, and voice activated software using speakers and microphone.

Referring now back to FIG. 2, at 202, an ML model is accessed and/or trained, for example, as described with reference to FIG. 3.

The ML model is pre-trained to identify one or more regions in the source code to be modified to convey, to a service engine, one or more data elements indicating interaction of multiple players with the game engine.

Briefly, the ML model may be trained on a training dataset of records. A record may include a sample source code of a sample game engine, and a ground truth indicating at least one region in the sample code to be modified to convey, to a sample service engine, information related to how multiple players interact with the sample game engine.

The record may include other features, for example, the ground truth may indicate which data elements are associated with each region, the ground truth of the record may include at least one recommendation for adapting the region(s) optionally according to the data element(s) associated with the region(s), the record may include one or more parameters of the sample game engine and/or the sample service engine (e.g., type, software vendor, computational platform), and/or aspects-to-be-revealed which may relate to aspects of interaction that are of interest to the user of the service engine. The aspects-to-be-revealed may correspond to the available data elements.

At 204, a source code for implementing a game engine is accessed. The game engine is designed to interact with multiple players. The multiple players may interact with the game engine via respective client terminals accessing the game engine running on a server over a network. The server hosting the game engine may be different than a server hosting the service engine. The multiple players may simultaneously access the game engine, and/or may access the game engine at different times.

The game engine may be configurable for interacting with different service engines, which may be running on different computing platforms. The source code may be modified for the game engine to interact with a specific service engine which may be running on a specific computing platform.

At 206, the source code is fed into the ML model (also referred to herein as the ML model is applied to the source code).

Optionally the source code is fed into the ML model in combination with a set of aspects-to-be-revealed that indicate how the players are interacting with the game engine, optionally in real time. The set of aspects-to-be-revealed may relate to aspects of interaction that are of interest to the user of the service engine. The set of aspects-to-be-revealed may be selected from the set of the data elements, for example, as the data elements that the user wishes to convey to the service engine from the game engine. For example, the user may select some data elements which are significant, such as for conveying of important data to the service element, and/or for monitoring interactions of players. The selection of the set of aspects-to-be-revealed acts as an indication to the ML model of which data elements are to be created and/or utilized by conveying to the service engine. The set of aspects-to-be-revealed may indicate data elements which may be monitored, for example, by presenting their values in the interface (e.g., GUI) which may be generated by the ML as described herein. The interface may be presented on a display of a client terminal in communication with the service engine.

Alternatively or additionally, the source code is fed into the ML model in combination with other data, for example, one or more parameters of the game engine and/or service engine, and/or an indication of one or more data elements which are to be conveyed by the game engine to the service engine.

Alternatively or additionally, one or more features are extracted from the source code. At least one of the extracted feature(s) is associated with one or more regions of the source code. Optionally, at least one of the extracted feature(s) is associated with one or more aspects-to-be-revealed. The extracted features may be fed into the ML model, optionally in combination with corresponding region of the source code, and/or the source code or portions thereof, and/or with the other data. Examples of features that may be extracted from source code include: AST (e.g., as described with reference to FIGS. 4A-4D, breaking the source code into tokens (e.g., keywords, identifiers, operators) that capture the basic building blocks of the source code, number of lines of code, number of tokens, number of functions, location of functions, parameters regarding function calls, how variables are used, parameters of comments to the source code, calls to external libraries and/or APIs, generating embeddings of the code (e.g., word2vec), history of changes to the code, error handling, and the like.

At 208, the ML model generates one or more outcome in response to the feeding.

The outcome may indicate one or more regions in the source code which are identified for modification, to convey, to the service engine, one or more data elements indicating interaction of multiple players with the game engine. In embodiments in which features are extracted from the source code, the suggestion is for modification of the region(s) corresponding to at least one of the extracted features. Optionally, the suggestion is for modification of the region(s) corresponding to at least one of the extracted features and to the selected aspects-to-be-revealed.

The modification may be to perform the conveying in real time or near real time, during interaction of the multiple players with the game engine.

Optionally, the outcome may further include an indication of which data element(s) are associated with different regions of the source code. For example, a first region of the source code is to be modified to convey a first type of data element to the service engine, and a second region of the source code is to be modified to convey a second type of data element to the service engine.

Alternatively or additionally, the outcome may further include one or more suggestions for modification of region(s) of the source code to send the data element(s) to the service engine, during interaction of the players with the game engine. The suggestions may be for data element(s) associated with different regions. The suggestions may include human readable instructions presented to a user that will manually make the modification. In another example, the suggestion may include a proposed modification to the actual source code, for example, shown by a “track changes” feature to the existing source code indicating what the modified source code should look like.

Examples of the data element indicating interaction of the multiple players with the game engine include:
Activity logs; may record a chronological sequence of events and actions performed by players within the game. For example: login times, achievements unlocked, items purchased, and other notable in-game activities. Analyzing activity logs can provide insights into player behavior, preferences, and engagement patterns. Activity logs may be valuable for debugging, tracking user progress, and refining game design.
Time spent in various attractions/stages within the game engine; this feature may tracks the amount of time players spend in different areas or stages within the game. It may help measure player interest and engagement with specific game content. Understanding time spent in various attractions/stages may help identify popular or challenging elements of the game. Game developers may use this data to optimize content, improve user experience, or focus on areas that need enhancement.
Interactions between the different players; for example, multiplayer battles, cooperative gameplay, messaging, and other collaborative or competitive actions. Monitoring player interactions may facilitate the creation of social features, fosters community building, and/or may help identify potential issues like harassment or cheating.
Gaming status; for example, whether a player is online, offline, in a match, or engaged in other specific game-related activities. This information may be used for providing real-time updates to friends, coordinating multiplayer sessions, and enhancing social aspects of the game.
Inventory of in-game items; for keeping track of items, weapons, cosmetics, or other virtual possessions owned by a player within the game. Managing inventory may be used for gameplay progression, customization, and in-game economies. Inventory of in-game items may be relevant for personalizing the gaming experience.
In-game trading; may facilitate the exchange of in-game items or currency between players. In-game trading may promote player interaction, fosters a virtual economy, and/or may be a key element of games with a focus on player-driven markets.
Entire and/or part of a data structure describing a state of each of at least one of the players; may represent the state of a player's progress, for example, achievements, completed quests, and other relevant game data. This data structure may be used for saving and loading game progress, enabling players to continue their journey across different gaming sessions or devices.
In-game messages created by the players; whether in the form of chat, notifications, or other communication within the game. In-game messaging may support social interaction, team coordination, and/or community building. In-game messages may be used for multiplayer and online games.
Latencies as experienced by the players in conjunction with playing the game; measures the time delay (latency) between a player's action and the corresponding in-game response. Monitoring latencies may be used for optimizing game performance, ensuring a smooth gaming experience, and/or addressing potential issues like lag in multiplayer scenarios.
A log of user interface activities comprising interactions with a user screen in conjunction with player the game; records player interactions with the game's user interface, including menu navigation, button clicks, and screen touches. Analyzing user interface activities may help improve the overall user experience, identify navigation issues, and/or refine the game's interface design.
Interactions with in-game stores; tracks player transactions within in-game stores, for example, purchases of virtual goods or currency. Understanding interactions with in-game stores may be used for monetization strategies, pricing optimization, and improving the overall in-game economy.
Interactions with an in-game specific activities; may include player engagement with specific in-game activities, for example, completing quests, participating in events, or achieving milestones. Monitoring interactions with specific activities may help game developers assess the popularity and success of different game features.
In-game token and/or currency status; tracking the amount of in-game currency or tokens held by a player. This information may be used for managing virtual economies, balancing gameplay, and influencing player decisions related to in-game purchases.
Technical fault experienced by the players; may log instances of technical issues and/or faults encountered by players, for example, crashes, connectivity problems, and/or bugs. Monitoring technical faults may help developers identify and address issues promptly, which may improve overall game stability and player satisfaction.
Stages in purchasing funnel; may describe the different stages players go through in the process of making a purchase within the game. Analyzing the purchasing funnel may help optimize the user experience, identify potential drop-off points, and/or refine strategies to increase in-game sales.

Optionally, the outcome includes marking, in the source code, the modifications to make to the region(s) of the source code to be operative to send the data element(s) indicating interaction of the players with the game engine, to the service engine. For example, the region(s) of the source code are highlighted, bolded, underlined, italicized. In another example, a boundary box or other shape of borders may be generated around each region. In yet another example, the region(s) may be indexed. The user may click on an index element pointing to a specific region, to be automatically directed to the specific region.

Alternatively or additionally, the suggestion indicates one or more proposed modifications of the source code to be able to send the data element(s), during interaction of the players with the game engine, to reveal aspects in the set of aspects-to-be-revealed.

At 210, the ML model may generate one or more additional outcomes. Alternatively or additionally, another model which may be working in conjunction with the ML model, may generate the additional outcomes.

Optionally, the additional outcome includes metadata describing and/or characterizing the data element indicating interaction of the players with the game engine. The data element may be segmented into categories and/or priorities, and the metadata may include the categories and/or priorities. The categories of the data elements may refer to the examples of the data elements listed herein. The different types of data elements may be prioritized.

Alternatively or additionally, the additional outcome includes a metadata summary. The summary may be of the metadata which may be generated by the ML model and/or other model. The summary may be usable by a user of the service engine to facilitate interaction with and/or understanding of the data element(s) indicating interaction of the players with the game engine, for example, the metadata summary is in a human readable format explaining the metadata which may be coded.

At 212, modifications to the source code may be made according to the suggestion(s) generated by the ML model.

Optionally, all modifications may be made to all of the regions of the source code identified by the ML model according to the suggestion(s) generated by the ML model. Alternatively, partial modification may be made to some regions. Alternatively or additionally, other regions may remain unmodified. For example, a user may select which modifications to make, and which modifications to ignore.

The modifications based on the suggestions may be made, for example, by one or more of: by the ML model itself, by an accompanying agent such as a language degenerative model that automatically generates code, and/or manually by a human user.

The modifications may be designed for making the source code operative to send to the service engine, the data element(s) indicating interaction of the players with the game engine.

Alternatively or additionally, the modifications done to the source code may be to enable the service engine to access at least one dataset (e.g., database) of the game engine storing the data elements generated by interaction of the players with the game engine, and/or storing data generated by the interaction which may be used to compute the data elements.

Alternatively or additionally, the modifications done to the source code may be to enable access, by the service engine, to in-game messages associated with the players interacting with the game engine. The in-game messages may be messages sent by players to each other, for example, one player to another player, or by one player to a subset of players or to all other players.

Alternatively or additionally, the modifications done to the source code may be to enable to access, by the service engine, a data state associated with one or more of the players.

Alternatively or additionally, the modifications done to the source code may be to generate (e.g., in conjunction with the game engine), intermediate datasets (e.g., databases, data structures) for storing intermediate data elements to facilitate the conveying, to the service engine, the data element(s) indicating interaction of the players with the game engine. Examples of the intermediate sets (e.g., databases and/or data structures) include: streaming buffers, intermediate calculation buffers, and per-player databases for aggregating a current state of each of the players.

At 214, the source code may be modified to generate an interactive interface, optionally a graphical user interface (GUI).

The modification may be for generating the user interface in conjunction with the game engine. The user interface may be associated with the service engine. The user interface may be designed to be used by a user of the service engine to facilitate performing of a selection of which types of data element(s) to actively receive from multiple available data elements indicating interaction of the plurality of players with the game engine. For example, the GUI may be presented on a display of a client terminal of a user accessing the service engine.

In some embodiments, the source code is modified with the capability of generating multiple data elements, and the user interface enables the user to select a subset or all of the data elements enabled by the source code, also referred to herein as aspects-to-be-revealed. The user may use the user interface to dynamically adapt the selected data elements. In another example, the user interface presents candidate data elements which may be enabled by the source code. The user may select a subset or all of the candidate data elements. The source code may be modified to enable the user selected data elements.

Alternatively or additionally, the user interface is designed to facilitate adjustments regarding generation and/or reception of the data element(s) indicating interaction of the players with the game engine. For example, the user interface enables selecting the aspects-to-be-revealed in conjunction with how the players interact with the game engine.

At 216, the source code including the modifications may be compiled to create an executable code, for example, by a studio. When executed by a processor(s) the executable modified source code, in addition to implementing the game engine, also executes the feature of conveying, to the service engine, the data element(s) indicating interaction of the players with the game engine.

The source code may have been modified for conveying of the data element(s) by the game engine to the service engine via a selected protocol for communicating with a virtual interface (e.g., software development kit (SDK) and/or application programming interface (API) of a communication network.

At 218, during execution of the game engine incorporating the modifications, the game engine sends the data element(s) indicating interaction of the players with the game engine, to the service engine.

The executing game engine may send the data element(s) to the game engine via the selected protocol for communicating with the virtual interface (e.g., SDK and/or API) of the communication network, for example, when the game engine is hosted by a server that is different than a server hosting the service engine.

The game engine may send the data element(s) to the service engine, for example, continuously, in response to obtaining a new data element(s), after accumulation of a certain amount of data element(s) (e.g., queue fills up), at present time intervals (e.g., even second, 30 seconds, 1 minute, 5 minutes, and the like), and/or triggered by events. Different data elements, which may be generated at different rates, may be sent at different rates such as corresponding to their generation rates. Alternatively or additionally, different data elements generated at different rates are sent at a common rate (e.g., together).

At 220, interactions of the players with the executing game engine (created by compiling the modified source code) may be monitored. The monitoring may be performed, for example, by a monitoring agent embedded within the game engine.

The monitored interactions may be analyzed to identify the data element(s) to convey to the service engine. For example, identifying changes of the data element(s) relative to historical baselines, for example, new data element(s) being used, previously used data element(s) no longer being used, increase in use of data element(s), and/or decrease in use of data element(s)

At 222, one or more features described with reference to 204-220 may be iterated. The iterations may be performed for dynamically modifying the source code to convey different data element(s) to the service engine according to the monitored interactions between players and the executing game engine.

During iterations, the ML model may be applied to the source code of the service engine to identify the region(s) in the source code to be modified to convey, to the service engine, the data element(s) identified by the analysis of the monitored interaction of the players with the game engine. The ML model may identify region(s) of the source code for improving performance of a computing platform running the game engine and/or a computing platform running the service engine in view of interaction of the players with the game engine. For example, for increasing performance of the computing platform hosting the game engine conveying the data element(s) to the service engine. In the example, the monitoring may determine that players tend to interact often with a first non-playable character (NPC) controlled by artificial intelligence, having a high latency due to the many players that interact with it, while few or no players interact with a second NPC having a low latency due to the few or no players that interact with it, resulting in decreased performance. The source code may be dynamically modified and re-complied to reduce latency for the first NPC and increase the latency for the second NPC or entirely remove the second NPC from the game, to improve performance of the computing platform running the game engine.

Referring now back to FIG. 3, at 302, a sample source code of a sample game engine is accessed. The sample game engine may be designed to run on different types of service engines.

At 304, one or more regions in the sample source code are identified, for example, manually by a user marking the regions. The user may mark the regions using a user interface, optionally a graphical user interface (GUI), for example, by highlighting the regions, drawing a border around the region, and/or clicking on the region. Alternatively or additionally, user modifications to the sample source code are monitored, for example, different developers making modifications to different sample codes for their own requirements may be monitored. The monitoring may be automatically performed, for example, by monitoring code that compares the modified source code to the original (or previous version) of the source code, and/or by monitoring the user interface the user is using to make the modifications. Pairs of the source code (e.g., as in 302) and the modified source code may be automatically generated. Alternatively or additionally, the modification to the source code may be automatically performed by a large language model (LLM) or other model trained to automatically make modifications to source code in response to instructions by a user.

The identified regions of the source code are to be modified to convey, to a service engine, one or more data elements indicating interaction of multiple players with the game engine.

At 306, additional data may be obtained. The additional data may be manually entered by a user (e.g., via the GUI) and/or automatically extracted by code (e.g., by analyzing data generated by the game engine and/or service engine).

Examples of additional data include:
One or more features (e.g., as described herein) extracted from the source code. One or more of the extracted features may be associated with one or more regions of the source code. One or more of the extracted features may be associated with one or more aspects-to-be-revealed.
Parameters of the sample game engine (e.g., software vendor, platforms it can run on).
Parameters of the service engine (e.g., software vendor, platforms it can run on).
Data elements which are to be conveyed to the service engine. The region(s) of the source code may be mapped to the data element(s).
Modifications made to the regions of the source code. The modifications may be used for training the ML model to actually make the modifications to the source code. Alternatively or additionally, the modifications may be used for training the ML model to suggest the recommendations to be made to the source code, where the modifications may be made by the user (i.e., manually) and/or approved by the user for being performed automatically (e.g., by the ML model).
Metadata describing and/or characterizing the data element indicating interaction of the players with the game engine. The metadata may be manually written by a user and/or automatically generated by a running process (e.g., another model).
A summary of the metadata. The summary may be manually written by a user and/or automatically generated by a running process (e.g., another model).

At 308, a record may be created. The record may include the source code and a ground truth. The ground truth may include the modifications made to the regions of the code.

The record may include other data according to the desired input into the ML model and/or desired outcome to be generated by the ML model. For example, the record may include data elements mapped to the regions, such as when during inference the ML model is fed the source code in combination with a set of aspects to be revealed. In another example, the record may include parameters of the game engine and/or service engine, such as when the ML model is trained to support modifications of different types of game engines or a specific type of game engine, for running on different types of service engines or a specific type of service engine. In another example, the ground truth may include the metadata and/or the metadata summary, such as when it is desired for the ML model to generate the metadata and/or metadata summary in response to input of the source code.

The record may include one or more features extracted from the source code. The record may include the features without the source code and/or other data, and/or may include the source code and/or other data. The ground truth may indicate the region(s) to be modified corresponding to the feature of the record. The ground truth may indicate the region(s) to be modified corresponding to the feature of the record and to selected aspects-to-be-revealed.

At 310, features described with reference to 302-308 may be iterated, for creating multiple records. One or more training datasets that include the generated records may be created.

Different types of records may be created for different training datasets, according to the target input and target outcome of the ML model. For example, for handling different types of game engines, different types of service engines, whether the ML model is to identify the regions or perform the modification of the region of the source code, whether the ML model is to generate metadata and/or metadata summary, and the like.

At 312, one or more ML models may be trained on the one or more training datasets. The trained ML model is as described herein.

The architecture of the ML model may be designed to process text and/or other representation of source code. Exemplary architectures include neural networks of various architectures (e.g., convolutional, fully connected, deep, encoder-decoder, recurrent, transformer, graph), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised, and/or reinforcement learning. Machine learning models may be trained using supervised approaches and/or unsupervised approaches.

Referring now back to FIGS. 4A-4D, exemplary embodiments based on an AST representation of source code are now described. The AST representation of source code and/or reconversion from the AST representation back to the source code, may be computed by components of system 100 described with reference to FIG. 1. The AST representation may be implemented by one or more features described with reference to FIG. 2 and/or FIG. 3, for example, as described below.

The source code operative to implement the game engine described herein may be converted into an AST representation. The AST representation may be a generic AST representation that is independent of language-specific syntax of a programming language used to write the source code.

Using the AST representation may provide one or more of the following potential technical advantages:
Code Interpretation: Translating code into a generic AST format may enable analysis and/or understanding of the underlying operations of any code segment, independent of its language-specific syntax.
Code Augmentation: Leveraging the AST structure may enable automatic insertion of inferred code blocks where necessary. This process may involves analyzing the AST to identify potential areas for enhancement and/or optimization, and automatically generating and integrating these inferred code segments.
Code Reconstruction: Modifications made in the AST back may be reconverted into the original programming language. This process may ensure that enhancements and/or optimizations carried out in the AST representation are accurately reflected in the source code, regardless of the programming language.

An example of modifying FIG. 2 to use the AST representation is now described. Existing features may be modified to include features related to the AST representation, and/or new features may be added to FIG. 2 to include the features related to the AST representation.

The source code may be converted into the AST representation, optionally the generic AST representation, for example, by modification of feature 204 described with reference to FIG. 2 and/or by adding a new feature to FIG. 2.

The AST representation may be fed into the ML model (e.g., as an alternative or addition to feeding the source code), for example, by modification of features described with reference to 206 of FIG. 2.

The outcome generated by the ML model may include at least one suggestion for modification of at least one region of the generic AST representation, for example, by modification of features described with reference to 208 of FIG. 2.

The AST representation may be modified according to the suggestion generated by the ML model, (e.g., as an alternative or addition to modifying the source code), for example, by modification of features described with reference to 212 and/or 214 of FIG. 2. The modification to the region(s) of the AST representation may generate a modified AST representation. The modification may be automatic, for example, by the ML model itself and/or an accompanying agent. Alternatively or additionally, the modification may be manual, for example, made by a user via a user interface.

The modified AST representation may be reconverted to the modified source code in an original programming language used to write the source code, for example, by modification of features described with reference to 216 of FIG. 2 and/or by adding a new feature to FIG. 2.

An example of modifying FIG. 3 to use the AST representation is now described. Existing features may be modified to include features related to the AST representation, and/or new features may be added to FIG. 2 to include the features related to the AST representation.

The source code may be converted into the AST representation, optionally the generic AST representation, for example, by modification of feature 302 described with reference to FIG. 3 and/or by adding a new feature to FIG. 3.

The region(s) of the AST representation to be modified may be obtained (e.g., as an alternative or addition to regions of the source code for modifying) for example, by modification of feature 304 described with reference to FIG. 3.

The record may include a sample generic AST representation created from a sample source code of a sample game engine. The ground truth may indicate at least one region in the sample generic AST representation to be modified to convey, to the sample service engine, information related to how the players interact with the sample game engine. For example, by modification of feature 308 described with reference to FIG. 3.

The training dataset may be created from sample source code written in multiple different programming languages. The generic AST representations created from multiple different sample code written in multiple different programming languages are independent of language-specific syntax of a programming language used to write the source code, enabling for example to use similar or same analysis approaches that are independent of the underlying specific programing language. Feature 310 described with reference to FIG. 3 may be modified accordingly.

The trained ML model may be fed a generic AST representation of the source code of the game engine, and/or may generate a recommendation(s) for modifying the AST representation, and/or may generated a modified AST representation (by automatically making the modification(s)). Feature 312 described with reference to FIG. 3 may be modified.

Referring now back to FIG. 4A, an example of a source code (snippet) 402 is shown. Source code 402 may be part of a game engine, as described herein. Source code 402 is written in Pseudo-C #, but the same approach can be applied to any programming language.

Referring now back to FIG. 4B, a simplified AST representation 404 of source code 402 described with reference to FIG. 4A is shown. AST representation 404 of code snippet 402 is shown as a tree structure, where each node represents a specific operation. The AST may be considered as a tree of operations. This tree structure allows to easily analyze and/or manipulate the code, for example, automatically by a process (e.g., ML model and/or another agent) and/or manually by a user.

Referring now back to FIG. 4C, an augmentation 406 of AST representation 404 of FIG. 4B is shown. Augmentation may be performed for sending data element(s) to the service engine, during interaction of the players with the game engine, as described herein. Augmentation 406 is performed by adding ‘SendAnalyticsEvent’ 408, which is a new method call to the ‘OnClick’ method. The location for insertion of ‘SendAnalyticsEvent’ 408 may be determined, for example, by tracking (e.g., all) data dependencies and/or control flow dependencies between operations. This may allow for understanding of the code and/or for making intelligent decisions about how to augment the code.

Referring now back to FIG. 4D, a modified source code 410 created by reconverting modified AST of FIG. 4C, is shown. Modified source code 410 represents a modification of source code 402, that further includes new code 412. New code 412 of modified source coded 410 may be for sending data element(s) to a service engine during interaction of players with the game engine, as described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant game engines, service engines, and ML models will be developed and the scope of the terms game engine, service engine, and ML model, are intended to include all such new technologies a priori. As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of integration of a game engine with a service engine, comprising:
obtaining a source code operative to implement a game engine designed to interact with a plurality of players;
applying a machine learning (ML) model to the source code, wherein the ML model is pre-trained to identify at least one region in the source code to be modified to convey, to the service engine, at least one data element indicating interaction of the plurality of players with the game engine; and
receiving, from the ML model, at least a suggestion indicating modification of the at least one region of the source code to send the at least one data element to the service engine, during interaction of the players with the game engine.

2. The computer implemented method of claim 1, wherein at least the suggestion comprises at least marking, in the source code, the modifications to make to the at least one region of the source code to be operative to send the at least one data element indicating interaction of the plurality of players with the game engine.

3. The computer implemented method of claim 1, wherein at least the suggestion comprises actually making, by the ML model itself and/or an accompanying agent, in the at least one region of the source code, the modification to make the source code operative to send the at least one data element indicating interaction of the plurality of players with the game engine.

4. The computer implemented method of claim 1, further comprising:
making, in the at least one region of the source code, according to the at least the suggestion, the modifications to make the source code operative to send the at least one data element indicating interaction of the plurality of players with the game engine; and
compiling the source code including the modifications to create an executable code operative to, in addition to implementing the game engine, also execute the conveying, to the service engine, the at least one data element indicating interaction of the plurality of players with the game engine.

5. The computer implemented method of claim 4, further comprising:
sending, by the game engine, to the service engine, while the game engine incorporating the modifications is executing and the plurality of players are interacting with the game engine, the at least one data element indicating the interaction of the plurality of players with the game engine.

6. The computer implemented method of claim 1, wherein the at least one data element indicating interaction of the plurality of players with the game engine comprises at least one of: (i) activity logs, (ii) time spent in various attractions/stages within the game engine, (iii) interactions between the different players, (iv) gaming status, (v) inventory of in-game items, (vi) in-game trading, (vii) entire and/or part of a data structure describing a state of each of at least one of the players, (viii) in-game messages created by the players, (ix) latencies as experienced by the players in conjunction with playing the game, (x) a log of user interface activities comprising interactions with a user screen in conjunction with player the game, (xi) interactions with in-game stores, (xii) interactions with an in-game specific activities, (xiii) in-game token and/or currency status, (xiv) technical fault experienced by the players, and (xv) stages in purchasing funnel.

7. The computer implemented method of claim 1, wherein the conveying of the at least one data element is done via a selected protocol for communicating with a virtual interface of the service engine over a communication network, wherein the game engine is hosted by a first server that is different than a second server hosting the service engine.

8. The computer implemented method of claim 1, wherein the modifications done to the source code are operative for the service engine to access at least one database of the game engine storing data generated by interaction of the plurality of players with the game engine used to compute the at least one data element.

9. The computer implemented method of claim 1, wherein the modifications done to the source code are operative to access, by the service engine, in-game messages associated with the plurality of players interacting with the game engine.

10. The computer implemented method of claim 1, wherein the modifications done to the source code are operative to access, by the service engine, a data state associated with at least one of the plurality of players.

11. The computer implemented method of claim 1, wherein the modifications done to the source code are operative to generate, in conjunction with the game engine, intermediate data bases and/or data structures operative to store intermediate data elements to facilitate the conveying, to the service engine, the at least one data element indicating interaction of the plurality of players with the game engine.

12. The computer implemented method of claim 11, wherein the intermediate data bases and/or data structures comprise at least one of: (i) streaming buffers, (ii) intermediate calculation buffers, and (iii) per-player databases operative to aggregate a current state of each of the players.

13. The computer implemented method of claim 1, further comprising: generating, by the ML model, and/or by another model working in conjunction with the ML model, metadata describing and/or characterizing the at least one data element indicating interaction of the plurality of players with the game engine.

14. The computer implemented method of claim 13, wherein the describing and/or characterizing comprises segmentation of the at least one data element into categories and/or priorities.

15. The computer implemented method of claim 1, further comprising: generating, by the ML model, and/or by another model working in conjunction with the ML model, a metadata summary usable by a user of the service engine to facilitate interaction with and/or understanding of the at least one data element indicating interaction of the plurality of players with the game engine.

16. The computer implemented method of claim 15, wherein the modifications done to the source code are operative to generate, in conjunction with the game engine, an interactive interface usable by a user of the service engine to facilitate performing of a selection of which types of data elements to actively receive from the at least one data element indicating interaction of the plurality of players with the game engine.

17. The computer implemented method of claim 15, wherein the modifications done to the source code are operative to generate, in conjunction with the game engine, an interactive interface usable by a user of the service engine to facilitate adjustments regarding generation and/or reception of the at least one data element indicating interaction of the plurality of players with the game engine.

18. The computer implemented method of claim 17, wherein the adjustments are associated with selecting aspects-to-be-revealed in conjunction with how the plurality of players interact with the game engine, wherein the selected aspects-to-be-revealed correspond to a set of candidate data elements.

19. The computer implemented method of claim 1, wherein the game engine is configurable for communicating with a plurality of different service engines running on a plurality of different computing platforms, and the source code is modified for the game engine to communicate with a specific service engine.

20. The computer implemented method of claim 1, wherein the ML model is trained on a training dataset of a plurality of records, wherein a record includes a sample source code of a sample game engine, and a ground truth indicating at least one region in the sample code to be modified to convey, to a sample service engine, information related to how the plurality of players interact with the sample game engine.

21. The computer implemented method of claim 20, wherein the ground truth of the record further comprises at least one recommendation for adapting the at least one region.

22. The computer implemented method of claim 1, further comprising:
monitoring interactions of the plurality of players with the game engine created by compiling the source code,
wherein the ML model is applied to the source code of the service engine to identify the at least one region in the source code to be modified to convey, to the service engine, the at least one data element indicating the monitored interaction of the players with the game engine.

23. The computer implemented method of claim 22, further comprising:
analyzing the monitored interaction to identify the at least one data element to convey to the service engine,
wherein the ML model is applied to the source code of the service engine to identify the at least one region in the source code to be modified to convey, to the service engine, the identified data.

24. The computer implemented method of claim 23, further comprising dynamically iterating the applying, the receiving, the monitoring the interactions, and the analyzing, for dynamic adaptation of the source code according to dynamic interactions between the plurality of players and the game engine.

25. The computer implemented method of claim 22, wherein the ML model identifies the at least one region of the source code for improving performance of a computing platform running the game engine and/or a computing platform running the service engine in view of interaction of the players with the game engine.

26. The computer implemented method of claim 22, wherein the monitoring is performed by a monitoring agent embedded within the game engine.

27. The computer implemented method of claim 1, wherein applying comprises applying the ML model to the source code in combination with a set of aspects-to-be-revealed in conjunction with how the plurality of players interact with the game engine, wherein the set of aspects-to-be-revealed correspond to a set of candidate data elements; and
wherein the suggestion indicates modification of the source code to be able to send at least one data element, during interaction of the players with the game engine, to reveal the aspects in the set.

28. The computer implemented method of claim 1, further comprising:
extracting at least one feature from the source code, the at least one feature associated with at least one region in the source code;
wherein the ML model is applied to the at least one feature;
wherein the at least one suggestion is for modification of the at least one region corresponding to the at least one feature.

29. The computer implemented method of claim 28, wherein:
extracting at least one feature comprises converting the source code to a generic abstract syntax tree (AST) representation that is independent of language-specific syntax of a programming language used to write the source code;
wherein the ML model is applied to the generic AST representation,
wherein the at least one suggestion is for modification of at least one region of the generic AST representation.

30. The computer implemented method of claim 29, wherein at least the suggestion comprises actually making, by the ML model itself and/or an accompanying agent, the modification in the at least one region of the generic AST representation to generate a modified AST representation, and further comprising reconverting the modified AST representation to a modified source code in an original programming language used to write the source code.

31. The computer implemented method of claim 29, wherein the ML model is trained on a training dataset of a plurality of records, wherein a record includes a sample generic AST representation created from a sample source code of a sample game engine, and a ground truth indicating at least one region in the sample generic AST representation to be modified to convey, to a sample service engine, information related to how the plurality of players interact with the sample game engine.

32. The computer implemented method of claim 31, wherein the training dataset is created from sample source code written in a plurality of different programming languages.

33. A system for integration of a game engine with a service engine, comprising:
at least one processor executing a code for:
obtaining a source code operative to implement a game engine designed to interact with a plurality of players;
applying a machine learning (ML) model to the source code, wherein the ML model is pre-trained to identify at least one region in the source code to be modified to convey, to the service engine, at least one data element indicating interaction of the plurality of players with the game engine; and
receiving, from the ML model, at least a suggestion indicating modification of the at least one region of the source code to send the at least one data element to the service engine, during interaction of the players with the game engine.

34. The system of claim 33, wherein a compilation of the game engine runs on a first server that is different than a second server running the service engine, where the at least one data element is created by the game engine while being interacted with by players, and the at least one data element is conveyed from the first server to the second server over a network.

35. The system of claim 34, wherein the at least one processor executing the code for obtaining the source code, applying the ML model, and receiving, runs on a third sever different from the first server and the second server.

36. A computer implemented method for training a ML model to identify at least one region in the source code to be modified to convey, to a service engine, at least one data element indicating interaction of a plurality of players with the game engine, comprising:
creating a training dataset of a plurality of records, wherein a record includes:
a sample source code of a sample game engine, and
a ground truth indicating at least one region in the sample code to be modified to convey, to a sample service engine, information related to how the plurality of players interact with the sample game engine, and at least one recommendation for adapting the at least one region; and
training the ML model on the training dataset.

37. The computer implemented method of claim 36, further comprising:
extracting at least one feature from the sample source code, the at least one feature associated with at least one region in the sample source code;
wherein the record includes the extracted at least one feature;
wherein the ground truth indicates the at least one region to be modified corresponding to the at least one feature.

38. The computer implemented method of claim 37, wherein
extracting at least one feature comprises converting the sample source code to a generic AST representation,
wherein the ground truth indicates the at least one region of the generic AST representation to be modified.

39. The computer implemented method of claim 37, wherein the training dataset is created from records for a plurality of different sample source code written in a plurality of different programming languages.
